(19) United States
(12) Patent Application Publication
(10) Pub. No.: US 2004/0017942 A1
(43) Pub. Date: Jan. 29, 2004

(54) System and method for performing optical character recognition on image data received from a document reading device

(76) Inventor: David J. Park, Torrance, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/202,601

(22) Filed: Jul. 24, 2002

(51) Int. Cl. G06K 9/00

(52) U.S. Cl. 382/181

(57) ABSTRACT

This invention is directed to a system and method for performing optical character recognition on image data received from a document reading device. More particularly, this invention is directed to a system and method for receiving image data from a document reading device, selecting optical character recognition parameters, and performing optical character recognition on the image data in accordance with the parameters.

### BACKGROUND OF THE INVENTION

This invention is directed to a system and method for performing optical character recognition on image data received from a document reading device. More particularly, this invention is directed to a system and method for receiving image data from a document reading device, selecting optical character recognition parameters, and performing optical character recognition on the image data in accordance with the parameters.

Typically, when a user uses a scanner, copier, or other document reading device, the generated image data is saved to shared network drives to be processed further. In order to perform further processing the user has to access the image data from the shared network drive and then go through a cumbersome process to move the data to a local workstation after the data is generated. For example, if a user wants to send the image data to an optical character recognition device, the user needs to move the data to a device that has the optical character recognition capability and send the data to such device.

There is a need for a system and method for easily performing optical character recognition on image data received from a document reading device.

### SUMMARY OF THE INVENTION

In accordance with the present invention, there is provided a system and method for easily performing optical character recognition on image data received from a document reading device.

Further, in accordance with the present invention, there is provided a system and method which enables users to easily convert image data to other application formats

Still further, in accordance with the present invention, there is provided a system for performing optical character recognition on image data received from a document reading device. The system comprises means adapted for receiving image data from an associated document reading device. The system further comprises means adapted for selecting optical character recognition parameters for performing optical character recognition on the image data. The system also comprises means adapted for performing optical character recognition on the image data and in accordance with selected optical character recognition parameters.

Still further in accordance with the present invention, there is provided a method for performing optical character recognition on image data received from a document reading device. The method comprises receiving image data from an associated document reading device. The method further comprises selecting optical character recognition parameters for performing optical character recognition on the image data. The system also comprises performing optical character recognition on the image data and in accordance with selected optical character recognition parameters.

Advantages of the system and method of the present invention, include, but are not limited to, the ability to easily transfer image data between a document reading device and an optical character recognition device and the ability to easily convert image data to other application formats.

These and other advantages, aspects, and features will be understood by one of ordinary skill in the art upon reading and understanding the specification.

### BRIEF DESCRIPTION OF THE DRAWINGS

FIG. 1 is a block diagram illustrating the preferred embodiment of the system according to the present invention.

FIGS. 2a, 2b, and 2c show sample templates for selecting the desired settings for the document reading device.

FIG. 3 shows a sample template for selecting the desired optical character recognition parameters for transmitting the generated image data to the file server.

### DETAILED DESCRIPTION OF THE PREFERRED EMBODIMENT

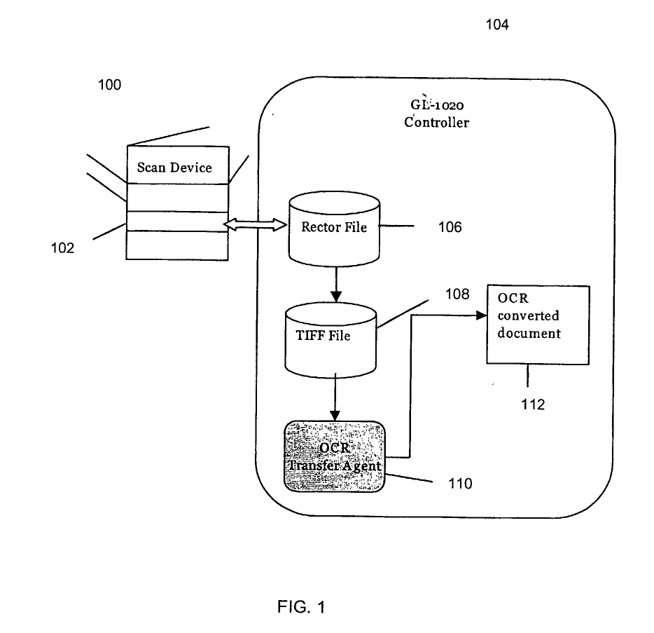

The present invention is directed to a system and method for performing optical character recognition on image data received from a document reading device. FIG. 1 shows a block diagram preferred embodiment of the system according to the present invention generally designated as 100. The system comprises a document reading device 102, such as a scanner or copier, for generating image data. The document reading device is any suitable document reading device known in the art. Preferably, the document reading device is a scanning device, a copying device, and similar device. More preferably, the document reading device is a scanning device. Suitable commercially available document reading devices include, but are not limited to, Toshiba e-Studio Series Controller. The document reading device further comprises a controller 104 which controls the functions of the document reading device and includes storage means for storing the image data.

In operation, the user inputs the document or other data into the document reading device to generate the image data and selects the desired settings for generating the image data. The image data is stored as a rector file 106 on the controller or any other suitable memory device. The image data is then converted by the controller to an appropriate format, such as TIFF, as shown by 108. An OCR Transfer Agent 110 within the controller is used to access the image data on the controller. The OCR Transfer Agent performs optical character recognition on the image data using a optical character recognition application or device to generate an optical character recognition converted document 112. Suitable optical character recognition applications or devices, include, but are not limited to, Clara OCR. In a preferred embodiment, depending on parameters selected by the user, the image data is converted to a selected format. The document generated by the optical character recognition device is stored at a specified location within the controller.

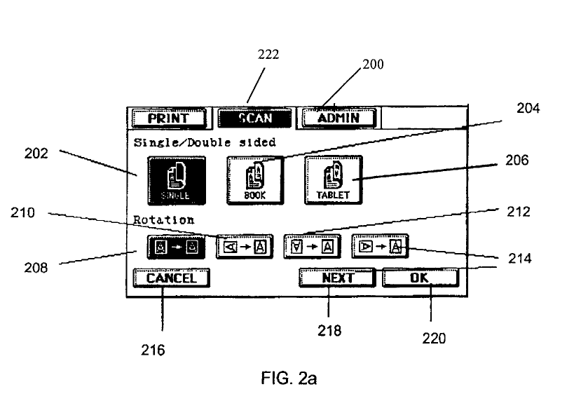

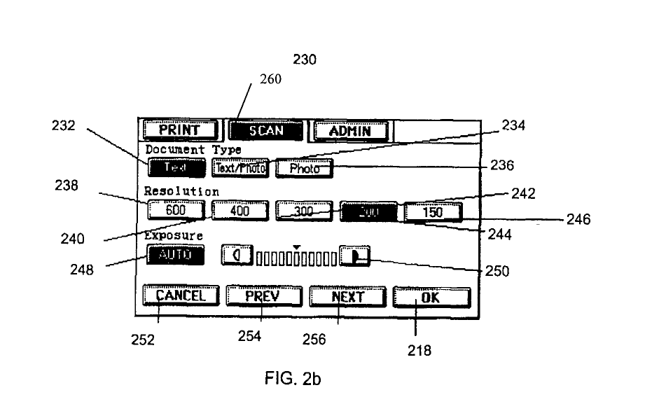

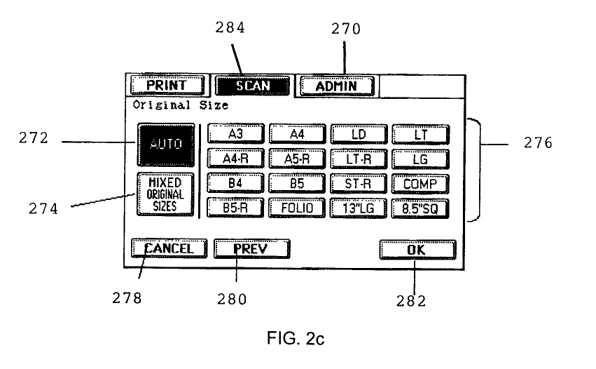

Preferred sample screen displays for selecting the desired settings for generating the image data is shown in FIGS. 2a, 2b, and 2c. FIG. 2a shows scanning parameter setting screen 1 shown as 200. The user selects if the document is to be scanned using a single page method 202, book method 204, or tablet method 206. The user next specifies the rotation from the four choices shown as 208, 210, 212, and 214. The user can cancel the settings by selecting the Cancel button 216. The user can go to scanning parameter screen 2 by selecting the Next button 218. The user can also proceed to selecting the appropriate agent and associated data transfer signal by selecting the OK button 220. The user can start the scanning process by selecting the Scan button 222.

FIG. 2b shows scanning parameter screen 2 as 230. The user first selects the document type as either text 232, text/photo 234, and photo 236. The user then selects the resolution for the image data from 600 dots per inch (dpi) 238, 400 dpi 240, 300 dpi 242, 200 dpi 244, and 150 dpi 246. The user then selects the exposure mode from Auto 248 or manual 250. The user can cancel the settings by selecting the Cancel button 252. The user can go back to scanning parameter screen 1 by selecting the Prev button 254. The user can go to scanning parameter screen 3 by selecting the Next button 256. The user can also proceed to selecting the appropriate agent and associated data transfer signal by selecting the OK button 258. The user can start the scanning process by selecting the scanning button 260.

FIG. 2c shows scanning parameter screen 3 as 270. The user can select Auto 272 for auto paper size detection mode. The user can also select Mixed Original Sizes 274 for the mixed original sizes mode. The user can also select the original paper size from the choices shown in region 276. The user can cancel the settings by selecting the Cancel button 278. The user can go back to scanning parameter screen 2 by selecting the Prev button 280. The user can also proceed to selecting the appropriate agent and associated data transfer signal by selecting the OK button 282. The user can start the scanning process by selecting the Scan button 284.

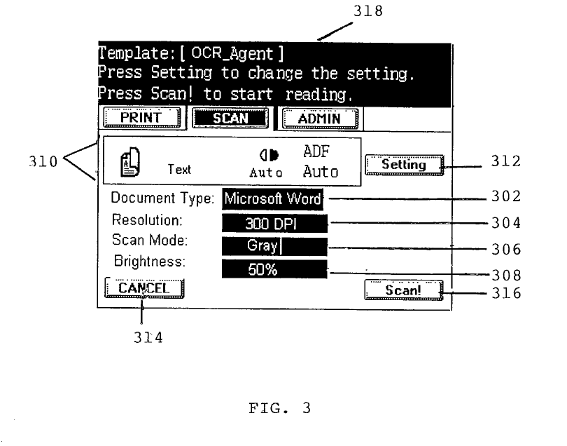

A preferred sample screen display 300 for selecting the desired optical character recognition parameters is shown in FIG. 3. The user first selects the particular document type in which the image data is to be transferred which is shown as 302. The user then inputs the resolution as OCR as shown in 304, the scan mode as shown in 306, and the brightness as shown in 308. The parameters selected for generating the image data as discussed above are shown in region 310. If the user desires to change the scanning parameters, the user selects the Setting button 312. If the user can cancel the optical character recognition parameters by selecting the Cancel button 314. The user can start the scanning process by selecting Scan button 316 or 318. The user can save this information by selecting the Update button 314.

Upon selecting the Scan button, either in the scanning parameters screens or the optical character recognition parameters screen, the controller 104 begins the process of generating the image data. The data is then converted to a TIFF image and the Scan to OCR Transfer Agent performs optical character recognition on the image data. The resulting document is saved on the controller.

While in the preferred embodiment the present invention is implemented in software, as those skilled in the art can readily appreciate it may also be implemented in hardware or a combination of software and hardware.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed is:

1. A system for performing optical character recognition on image data received from a document reading device comprising:
means adapted for receiving image data from an associated document reading device;
means adapted for selecting optical character recognition parameters for performing optical character recognition on the image data; and
means adapted for performing optical character recognition on the image data and in accordance with selected optical character recognition parameters.

2. The system according to claim 1 further comprising means adapted for converting the image data to at least one selected format prior to performing optical character recognition on the image data.

3. The system according to claim 2 wherein image data is first converted to rector format and is then converted to TIFF format prior to performing optical character recognition on the image data.

4. The system according to claim 1 further comprising means adapted for converting the image data to a selected format after performing optical character recognition on the image data.

5. The system according to claim 1 further comprising means adapted for storing the image data after performing optical character recognition on the image data.

6. The system according to claim 1 further comprising means adapted for selecting parameters for generating the image data.

7. The system according to claim 1 further comprising means adapted for transmitting the image data to a document device reader controller, wherein the controller includes the means adapted for selecting the parameters for optical character recognition and the means adapted for performing optical character recognition on the image data.

8. The system according to claim 7 wherein the document reading device controller further comprises means adapted for converting the image data to at least one selected format prior to performing optical character recognition on the image data.

9. The system according to claim 7 wherein the document reading device controller further comprises means adapted for converting the image data to a selected format after performing optical character recognition on the image data.

10. The system according to claim 7 wherein the document reading device controller further comprises means adapted for storing the image data after performing optical character recognition on the image data.

11. The method for performing optical character recognition on image data received from a document reading device comprising:
receiving image data from an associated document reading device;
selecting optical character recognition parameters for performing optical character recognition on the image data; and
performing optical character recognition on the image data and in accordance with selected optical character recognition parameters.

12. The method according to claim 11 further comprising converting the image data to at least one selected format prior to performing optical character recognition on the image data.

13. The method according to claim 12 wherein image data is first converted to rector format and is then converted to TIFF format prior to performing optical character recognition on the image data.

14. The method according to claim 11 further comprising converting the image data to a selected format after performing optical character recognition on the image data.

15. The method according to claim 11 further comprising storing the image data after performing optical character recognition on the image data.

16. The method according to claim 11 further comprising selecting parameters for generating the image data.

17. The method according to claim 11 further comprising transmitting the image data to a document device reader controller, wherein the controller performs the steps of selecting the parameters for optical character recognition performing optical character recognition on the image data.

18. The method according to claim 17 wherein the document reading device controller performs the step of converting the image data to at least one selected format prior to performing optical character recognition on the image data.

19. The method according to claim 17 wherein the document reading device controller performs the step of converting the image data to a selected format after performing optical character recognition on the image data.

20. The method according to claim 17 wherein the document reading device controller performs the step of storing the image data after performing optical character recognition on the image data.

21. A computer readable medium of instructions for performing optical character recognition on image data received from a document reading device comprising:
means adapted for receiving image data from an associated document reading device;
means adapted for selecting optical character recognition parameters for performing optical character recognition on the image data; and
means adapted for performing optical character recognition on the image data and in accordance with selected optical character recognition parameters.

22. The computer readable medium according to claim 21 further comprising means adapted for converting the image data to at least one selected format prior to performing optical character recognition on the image data.

23. The computer readable medium according to claim 22 wherein image data is first converted to rector format and is then converted to TIFF format prior to performing optical character recognition on the image data.

24. The computer readable medium according to claim 21 further comprising means adapted for converting the image data to a selected format after performing optical character recognition on the image data.

25. The computer readable medium according to claim 21 further comprising means adapted for storing the image data after performing optical character recognition on the image data.

26. The computer readable medium according to claim 21 further comprising means adapted for selecting parameters for generating the image data.

27. The computer readable medium according to claim 21 further comprising means adapted for transmitting the image data to a document device reader controller, wherein the controller includes the means adapted for selecting the parameters for optical character recognition and the means adapted for performing optical character recognition on the image data.

28. The computer readable medium according to claim 21 wherein the document reading device controller further comprises means adapted for converting the image data to at least one selected format prior to performing optical character recognition on the image data, means adapted for converting the image data to a selected format after performing optical character recognition on the image data, and means adapted for storing the image data after performing optical character recognition on the image data.

29. A computer-implemented method for performing optical character recognition on image data received from a document reading device comprising:
receiving image data from an associated document reading device;
selecting optical character recognition parameters for performing optical character recognition on the image data; and
performing optical character recognition on the image data and in accordance with selected optical character recognition parameters.

30. The computer-implemented method according to claim 29 further comprising converting the image data to at least one selected format prior to performing optical character recognition on the image data.

31. The computer-implemented method according to claim 30 wherein image data is first converted to rector format and is then converted to TIFF format prior to performing optical character recognition on the image data.

32. The computer-implemented method according to claim 29 further comprising converting the image data to a selected format after performing optical character recognition on the image data.

33. The computer-implemented method according to claim 29 further comprising storing the image data after performing optical character recognition on the image data.

34. The computer-implemented method according to claim 29 further comprising selecting parameters for generating the image data.

35. The computer-implemented method according to claim 29 further comprising transmitting the image data to a document device reader controller, wherein the controller performs the steps of selecting the parameters for optical character recognition performing optical character recognition on the image data.

36. The computer-implemented method according to claim 35 wherein the document reading device controller performs the steps of converting the image data to at least one selected format prior to performing optical character recognition on the image data, converting the image data to a selected format after performing optical character recognition on the image data, and storing the image data after performing optical character recognition on the image data.
